(19) United States
(12) Patent Application Publication
(10) Pub. No.: US 2020/0346227 A1
(43) Pub. Date: Nov. 5, 2020

(54) Wheel Tub Spraying Device

(71) Applicant: Timothy F. McNaughton, Assiniboia (CA)

(72) Inventor: Timothy F. McNaughton, Assiniboia (CA)

(21) Appl. No.: 16/399,515

(22) Filed: Apr. 30, 2019

(51) Int. Cl. B05B 1/10; B23B 41/00; B08B 3/02; B60S 3/04

(52) U.S. Cl. CPC B05B 1/10; B60S 3/044; B08B 3/02; B23B 41/00

(57) ABSTRACT

A wheel tub spraying device for preventing rusting of a wheel tub and adjacent body panels includes a pipe that a first end, which is closed. A coupler that is coupled to a second end of the pipe is configured to couple to a tube that extends from a source of pressurized water so that the pipe is fluidically coupled to the source of pressurized water. A plurality of holes that is positioned in the first end of the pipe is configured to increase a velocity of water that exits the pipe through the holes. A user positions the first end of the pipe proximate to a respective aperture of a plurality of apertures that is positioned in a respective wheel well of a vehicle to clean an associated wheel tub of the vehicle. Maintaining the wheel tub clean and dry deters rusting of the wheel tub and adjacent panels.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to spraying device and more particularly pertains to a new spraying device for preventing rusting of a wheel tub and adjacent body panels.

### (2) Description of Related Art Including Information Disclosed Under 37 CFR 1.97 and 1.98

The prior art relates to spraying devices.

### BRIEF SUMMARY OF THE INVENTION

An embodiment of the disclosure meets the needs presented above by generally comprising a pipe that a first end, which is closed. A coupler that is coupled to a second end of the pipe is configured to couple to a tube that extends from a source of pressurized water so that the pipe is fluidically coupled to the source of pressurized water. A plurality of holes that is positioned in the first end of the pipe is configured to increase a velocity of water that exits the pipe through the holes. A user positions the first end of the pipe proximate to a respective aperture of a plurality of apertures that is positioned in a respective wheel well of a vehicle to clean an associated wheel tub of the vehicle. Maintaining the wheel tub clean and dry deters rusting of the wheel tub and adjacent body panels.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a wheel tub spraying device according to an embodiment of the disclosure.

FIG. 2 is an isometric perspective view of an embodiment of the disclosure.

FIG. 3 is an in-use view of an embodiment of the disclosure.

FIG. 4 is an in-use view of an embodiment of the disclosure.

FIG. 5 is an exploded view of an embodiment of the disclosure.

### DETAILED DESCRIPTION OF THE INVENTION

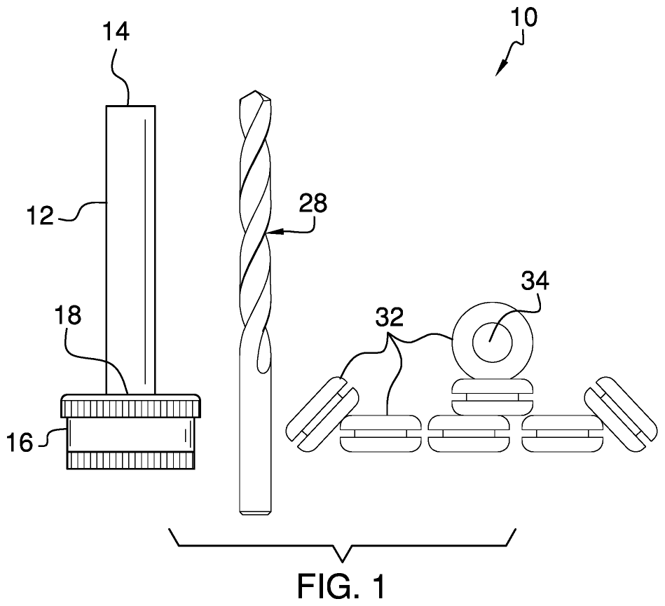

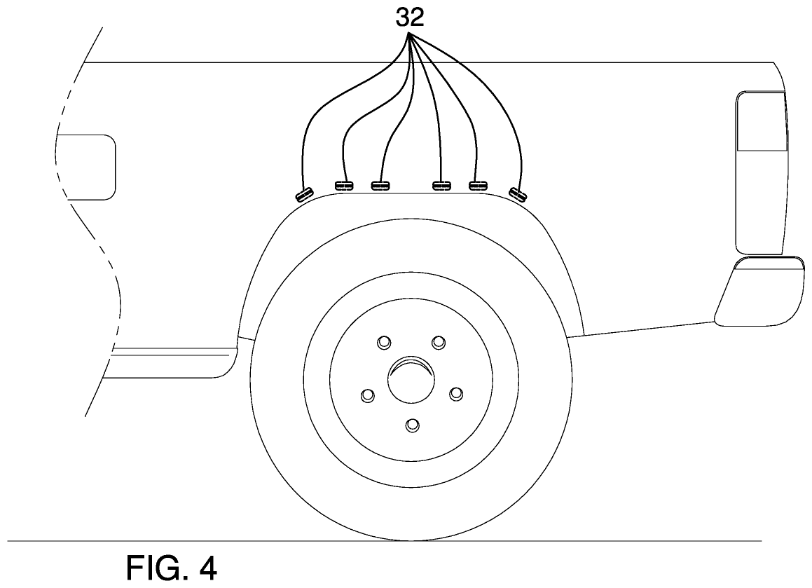

With reference now to the drawings, and in particular to FIGS. 1 through 5 thereof, a new spraying device embodying the principles and concepts of an embodiment of the disclosure and generally designated by the reference numeral 10 will be described.

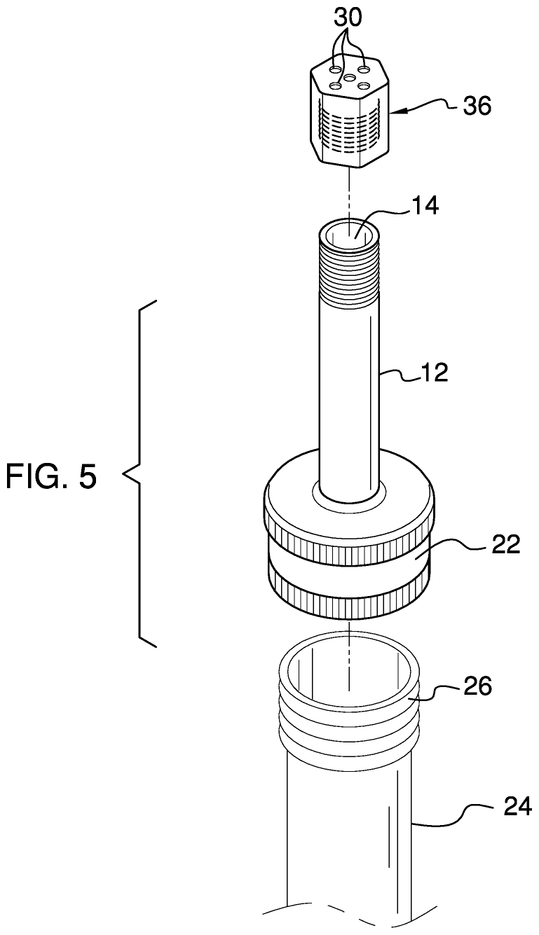

As best illustrated in FIGS. 1 through 5, the wheel tub spraying device 10 generally comprises a pipe 12 that a first end 14, which is closed. A coupler 16 that is coupled to a second end 18 of the pipe 12 is configured to couple to a tube 20 that extends from a source of pressurized water so that the pipe 12 is fluidically coupled to the source of pressurized water. The coupler 16 comprises a female hose connector 22, which can be used to couple the pipe 12 to a garden hose 24, or the like, via a male hose connector 26, as shown in FIG. 5.

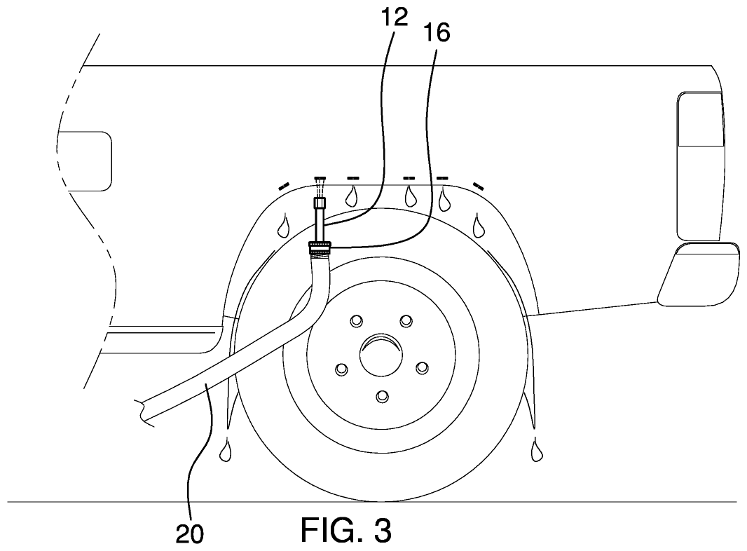

The device 10 also comprises a drill bit 28 that is circumferentially smaller than the pipe 12. The drill bit 28 is configured to couple to a rotary tool to drill a plurality of apertures in a respective wheel well of a vehicle, such as a pickup truck, as shown in FIG. 3.

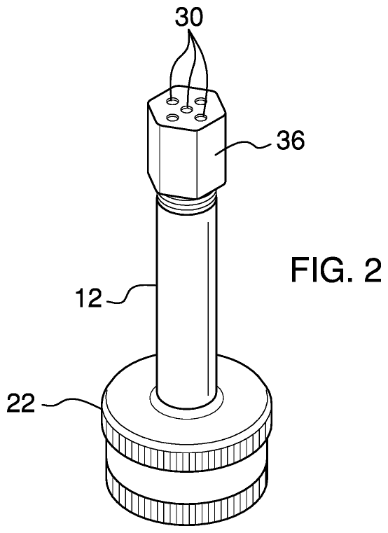

A plurality of holes 30 that is positioned in the first end 14 of the pipe 12, as shown in FIG. 2, is configured to increase a velocity of water that exits the pipe 12 through the plurality of holes 30. A user positions the first end 14 of the pipe 12 proximate to a respective aperture of the plurality of apertures that is positioned in the respective wheel well of the vehicle to clean an associated wheel tub of the vehicle. The waste water generated during the cleaning drains through the apertures. Maintaining the wheel tub clean and dry deters rusting of the wheel tub and adjacent body panels of the vehicle.

Each hole 30 is circular. The plurality of holes 30 comprises from two to twenty holes 30. The plurality of holes 30 comprises from three to twelve holes 30. The plurality of holes 30 comprises five holes 30.

The device 10 also comprises a plurality of grommets 32. Each grommet 32 is configured to position in a respective aperture and to be set with a setting tool so that the grommet 32 is sealably coupled to the wheel well. An opening 34 of the grommet 32 is configured for the user to position the first end 14 of the pipe 12 proximate to the opening 34 to clean the associated wheel tub of the vehicle. The grommet 32 is configured to protect exposed metal at a perimeter of the aperture.

In another embodiment of the invention, as shown in 5, the first end 14 of the pipe 12 is open, and the pipe 12 is threaded proximate to the first end 14. A cap 36 is selectively threadedly couplable to the first end 14 of the pipe 12 to close the first end 14. The cap 36 is hexagonally shaped when viewed longitudinally so that the cap 36 is configured to be tightened onto the pipe 12 with a wrench. In this embodiment, the plurality of holes 30 is positioned in the cap 36. The holes 30 are configured to increase the velocity of the water that exits the pipe 12 through the plurality of holes 30. The user positions the cap 36 proximate to the aperture that is positioned in the respective wheel well of the vehicle, or to the opening 34 in a respective grommet 32 if the plurality of grommets 32 is installed, to clean the associated wheel tub of the vehicle.

In use, the drill bit 28 is used, along with the rotary tool, to drill the plurality of apertures in the wheel well of a vehicle. The grommet 32 are positioned singly in the apertures and set with the setting tool. The pipe 12 is coupled to the garden hose 24 via the female hose connector 22. The user then positions the first end 14 of the pipe 12 proximate to the opening 34 of the grommet 32 to clean the associated wheel tub of the vehicle. Maintaining the wheel tub clean and dry deters rusting of the wheel tub and adjacent body panels of the vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wheel tub spraying device comprising:
a pipe having a first end, the first end being closed;
a coupler coupled to a second end of the pipe, the coupler being configured for coupling to a tube extending from a source of pressurized water such that the pipe is fluidically coupled to the source of pressurized water; and
a plurality of holes positioned in the first end of the pipe wherein the holes are configured for increasing a velocity of water exiting the pipe through the plurality of holes positioning a user for positioning the first end of the pipe proximate to a respective aperture of a plurality of apertures positioned in a respective wheel well of a vehicle for cleaning an associated wheel tub of the vehicle.

2. The device of claim 1, further including the coupler comprising a female hose connector.

3. The device of claim 1, further including a drill bit, the drill bit being circumferentially smaller than the pipe wherein the drill bit is configured for coupling to a rotary tool for drilling the plurality of apertures in the respective wheel well of the vehicle.

4. The device of claim 1, further including each hole being circular.

5. The device of claim 1, further including the plurality of holes comprising from two to twenty holes.

6. The device of claim 5, further including the plurality of holes comprising from three to twelve holes.

7. The device of claim 6, further including the plurality of holes comprising five holes.

8. The device of claim 1, further including a plurality of grommets, each grommet being configured for positioning in a respective aperture and for setting with a setting tool such that the grommet is sealably coupled to the wheel well wherein an opening of the grommet is configured for the user to position the first end of the pipe proximate to the opening for cleaning the associated wheel tub of the vehicle and wherein the grommet is configured for protecting exposed metal at a perimeter of the aperture.

9. The device of claim 1, further comprising:
the first end of the pipe being open, the pipe being threaded proximate to the first end;
a cap selectively threadedly couplable to the first end of the pipe for closing the first end; and
the plurality of holes being positioned in the cap wherein the holes are configured for increasing the velocity of the water exiting the pipe through the plurality of holes positioning the user for positioning the cap proximate to the aperture positioned in the respective wheel well of the vehicle for cleaning the associated wheel tub of the vehicle.

10. The device of claim 9, further including the cap being hexagonally shaped when viewed longitudinally wherein the cap is configured for tightening onto the pipe with a wrench.

11. A wheel tub spraying device and hose combination comprising:
a tube coupled to and extending from a source of pressurized water;
a pipe having a first end, the first end being closed;
a coupler coupled to a second end of the pipe, the coupler being selectively couplable to the tube distal from the source of pressurized water such that the pipe is fluidically coupled to the source of pressurized water; and
a plurality of holes positioned in the first end of the pipe wherein the holes are configured for increasing a velocity of water exiting the pipe through the plurality of holes positioning a user for positioning the first end of the pipe proximate to a respective aperture of a plurality of apertures positioned in a respective wheel well of a vehicle for cleaning an associated wheel tub of the vehicle.

12. A wheel tub spraying device comprising:
a pipe having a first end, the first end being closed;
a coupler coupled to a second end of the pipe, the coupler being configured for coupling to a tube extending from a source of pressurized water such that the pipe is fluidically coupled to the source of pressurized water, the coupler comprising a female hose connector;
a drill bit, the drill bit being circumferentially smaller than the pipe wherein the drill bit is configured for coupling to a rotary tool for drilling a plurality of apertures in a respective wheel well of a vehicle;
a plurality of holes positioned in the first end of the pipe wherein the holes are configured for increasing a velocity of water exiting the pipe through the plurality of holes positioning a user for positioning the first end of the pipe proximate to a respective aperture of the plurality of apertures positioned in the respective wheel well of the vehicle for cleaning an associated wheel tub of the vehicle, each hole being circular, the plurality of holes comprising from two to twenty holes, the plurality of holes comprising from three to twelve holes, the plurality of holes comprising five holes; and
a plurality of grommets, each grommet being configured for positioning in a respective aperture and for setting with a setting tool such that the grommet is sealably coupled to the wheel well wherein an opening of the grommet is configured for the user to position the first end of the pipe proximate to the opening for cleaning the associated wheel tub of the vehicle and wherein the grommet is configured for protecting exposed metal at a perimeter of the aperture.

13. The device of claim 12, further comprising:
the first end of the pipe being open, the pipe being threaded proximate to the first end;
a cap selectively threadedly couplable to the first end of the pipe for closing the first end, the cap being hexagonally shaped when viewed longitudinally wherein the cap is configured for tightening onto the pipe with a wrench; and
the plurality of holes being positioned in the cap wherein the holes are configured for increasing the velocity of the water exiting the pipe through the plurality of holes positioning the user for positioning the cap proximate to the aperture positioned in the respective wheel well of the vehicle for cleaning the associated wheel tub of the vehicle.
